(19) United States
(12) Patent Application Publication
(10) Pub. No.: US 2015/0334320 A1
(43) Pub. Date: Nov. 19, 2015

(54) SOLID-STATE IMAGING DEVICE

(71) Applicant: KABUSHIKI KAISHA TOSHIBA, Tokyo (JP)

(72) Inventor: Hiroki SASAKI, Yokohama Kanagawa (JP)

(73) Assignee: KABUSHIKI KAISHA TOSHIBA, Tokyo (JP)

(21) Appl. No.: 14/473,384

(22) Filed: Aug. 29, 2014

(30) Foreign Application Priority Data
May 16, 2014 (JP) 2014-102767

(51) Int. Cl. H04N 5/361; H04N 5/351; H04N 5/378

(52) U.S. Cl. CPC H04N 5/361; H04N 5/378; H04N 5/351

(57) ABSTRACT

According to one embodiment, there is provided a solid-state imaging device including a charge storage portion and a photoelectric conversion portion. The charge storage portion is formed of a first semiconductor material. The photoelectric conversion portion is formed of a second semiconductor material having a narrower band gap than the first semiconductor material. The charge storage portion forms an overflow potential in a connection area with the photoelectric conversion portion so that charges generated in the photoelectric conversion portion in response to incident light can overflow the overflow potential into the charge storage portion.

### CROSS-REFERENCE TO RELATED APPLICATIONS

This application is based upon and claims the benefit of priority from Japanese Patent Application No. 2014-102767, filed on May 16, 2014 which are incorporated herein by reference.

### FIELD

Embodiments described herein relate generally to a solid-state imaging device.

### BACKGROUND

In solid-state imaging devices, each of multiple photoelectric conversion portions generates and stores an amount of charges according to incident light, and stored charges are read out from the photoelectric conversion portions to obtain an image signal. At this time, in order to improve the picture quality of an image obtained from the image signal, it is desired to improve the photoelectric conversion efficiency of each photoelectric conversion portion and reduce its dark current.

### BRIEF DESCRIPTION OF THE DRAWINGS

FIG. 1 is a diagram showing the configuration of an imaging system to which a solid-state imaging device according to an embodiment is applied;

FIG. 2 is a diagram showing the configuration of the imaging system to which the solid-state imaging device according to the embodiment is applied;

FIG. 3 is a diagram showing the circuit configuration of the solid-state imaging device according to the embodiment;

FIG. 4 is a diagram showing the in-cross-section configuration of the solid-state imaging device according to the embodiment;

FIG. 5 is a diagram showing the potential distribution in a cross-section of the solid-state imaging device according to the embodiment;

FIGS. 6A and 6B are diagrams showing the in-cross-section configuration and potential structure of the solid-state imaging device of the embodiment;

FIGS. 7A to 7F are diagrams showing the operation of the solid-state imaging device according to the embodiment;

FIGS. 8A to 8D are views showing a manufacturing method of the solid-state imaging device according to the embodiment;

FIG. 9 is a view showing the manufacturing method of the solid-state imaging device according to the embodiment;

FIGS. 10A to 10E are views showing a manufacturing method of the solid-state imaging device according to a modified example of the embodiment;

FIG. 11 is a view showing a manufacturing method of the solid-state imaging device according to another modified example of the embodiment;

FIG. 12 is a diagram showing the in-plane configuration of a solid-state imaging device according to the basic form;

FIGS. 13A and 13B are diagrams showing the in-cross-section configuration and potential structure of the solid-state imaging device according to the basic form;

FIG. 14 is a graph showing the relation between the wavelength of light and the absorption coefficient and penetration length thereof;

FIG. 15 is a graph showing the spectral sensitivity characteristic of silicon; and

FIG. 16 is a graph showing the spectral sensitivity characteristic of germanium.

### DETAILED DESCRIPTION

In general, according to one embodiment, there is provided a solid-state imaging device including a charge storage portion and a photoelectric conversion portion. The charge storage portion is formed of a first semiconductor material. The photoelectric conversion portion is formed of a second semiconductor material having a narrower band gap than the first semiconductor material. The charge storage portion forms an overflow potential in a connection area with the photoelectric conversion portion so that charges generated in the photoelectric conversion portion in response to incident light can overflow the overflow potential into the charge storage portion.

Exemplary embodiments of a solid-state imaging device will be explained below in detail with reference to the accompanying drawings. The present invention is not limited to the following embodiments.

### Embodiment

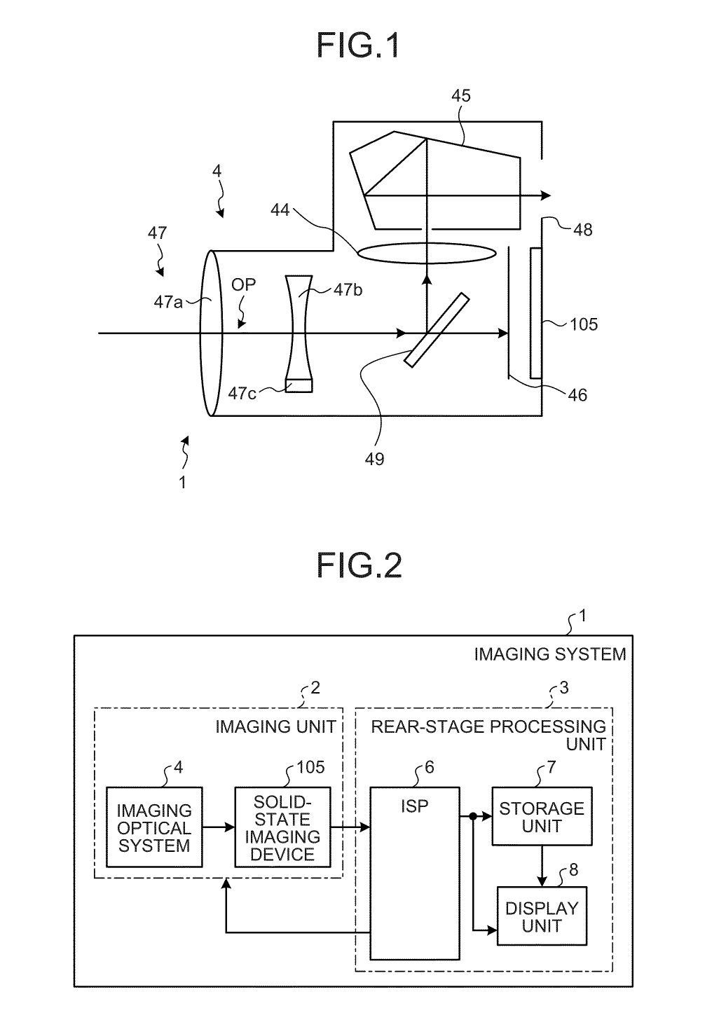

A solid-state imaging device according to the embodiment will be described. The solid-state imaging device is applied to, for example, an imaging system as shown in FIGS. 1 and 2. FIGS. 1 and 2 are diagrams showing schematically the configuration of the imaging system. In FIG. 1, OP indicates an optical axis.

The imaging system 1 may be, for example, a digital camera, a digital video camera, or the like, or a camera module incorporated in an electronic device (e.g., a mobile terminal with a camera). The imaging system 1 has an imaging unit 2 and a rear-stage processing unit 3 as shown in FIG. 2. The imaging unit 2 is, for example, a camera module. The imaging unit 2 has an imaging optical system 4 and the solid-state imaging device 105. The rear-stage processing unit 3 has an ISP (Image Signal Processor) 6, a storage unit 7, and a display unit 8.

The imaging optical system 4 has an imaging lens 47, a half mirror 43, a mechanical shutter 46, a lens 44, a prism 45, and a finder 48. The imaging lens 47 has pickup lenses 47a, 47b, a diaphragm (not shown), and a lens drive mechanism 47c. The diaphragm is placed between the pickup lenses 47a and 47b and adjusts the amount of light led to the pickup lens 47b. It should be noted that, although FIG. 1 shows illustratively the case where the imaging lens 47 has two pickup lenses 47a, 47b, the imaging lens 47 may have multiple pickup lenses.

The solid-state imaging device 105 is placed at a predicted imaging plane of the imaging lens 47. For example, the imaging lens 47 refracts incident light to lead via the half mirror 43 and the mechanical shutter 46 to the imaging plane of the solid-state imaging device 105 so as to form an image of an object on the imaging plane of the solid-state imaging device 105. The solid-state imaging device 105 generates an image signal according to the object image.

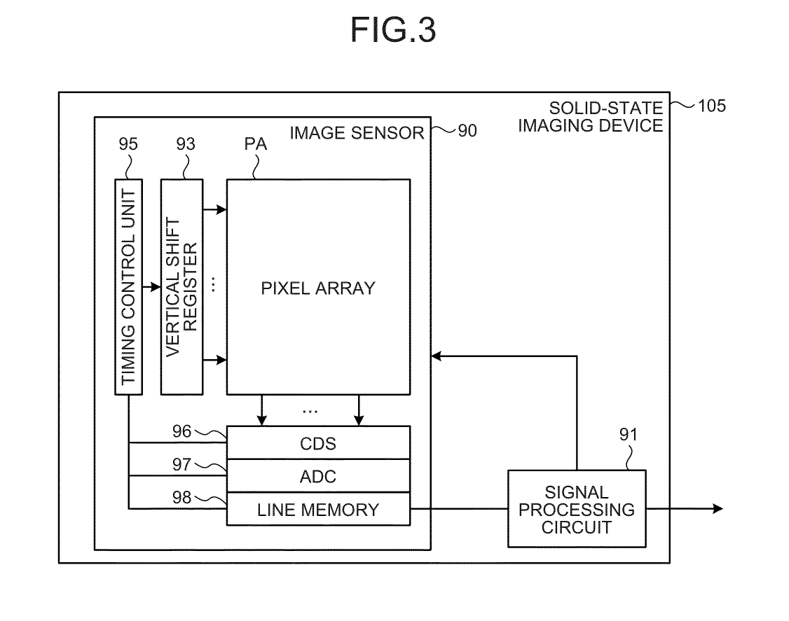

The solid-state imaging device 105 has an image sensor 90 and a signal processing circuit 91 as shown in FIG. 3. FIG. 3 is a diagram showing the circuit configuration of the solid-state imaging device 105. The image sensor 90 may be, for example, a CMOS image sensor or a CCD image sensor. The image sensor 90 has a pixel array PA, a vertical shift register 93, a timing control unit 95, a correlated double sampling unit (CDS) 96, an analog-to-digital converter (ADC) 97, and a line memory 98.

The pixel array PA has a plurality of pixels P arranged two-dimensionally. Each pixel generates an image signal according to the amount of light incident on the pixel. The generated image signals (analog signals) are read out to the CDS 96 side by the timing control unit 95 and the vertical shift register 93 and are converted into an image signal (digital signal) through the CDS 96 and the ADC 97 to be output via the line memory 98 to the signal processing circuit 91. The signal processing circuit 91 performs signal processing on the image signal to generate image data. The generated image data is output to the ISP 6.

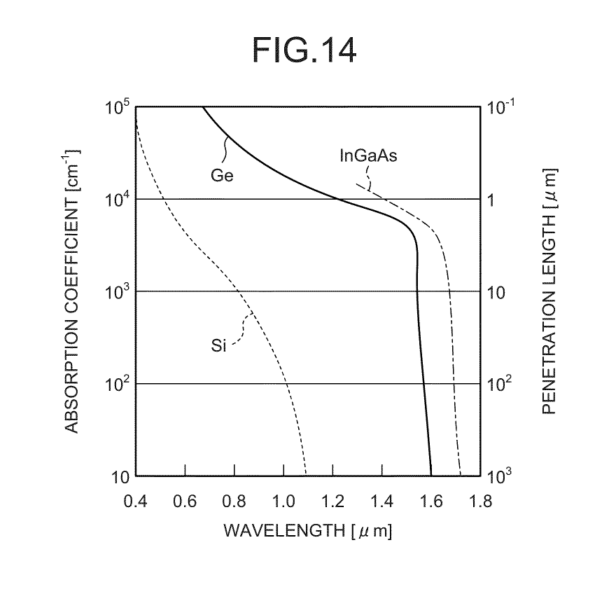

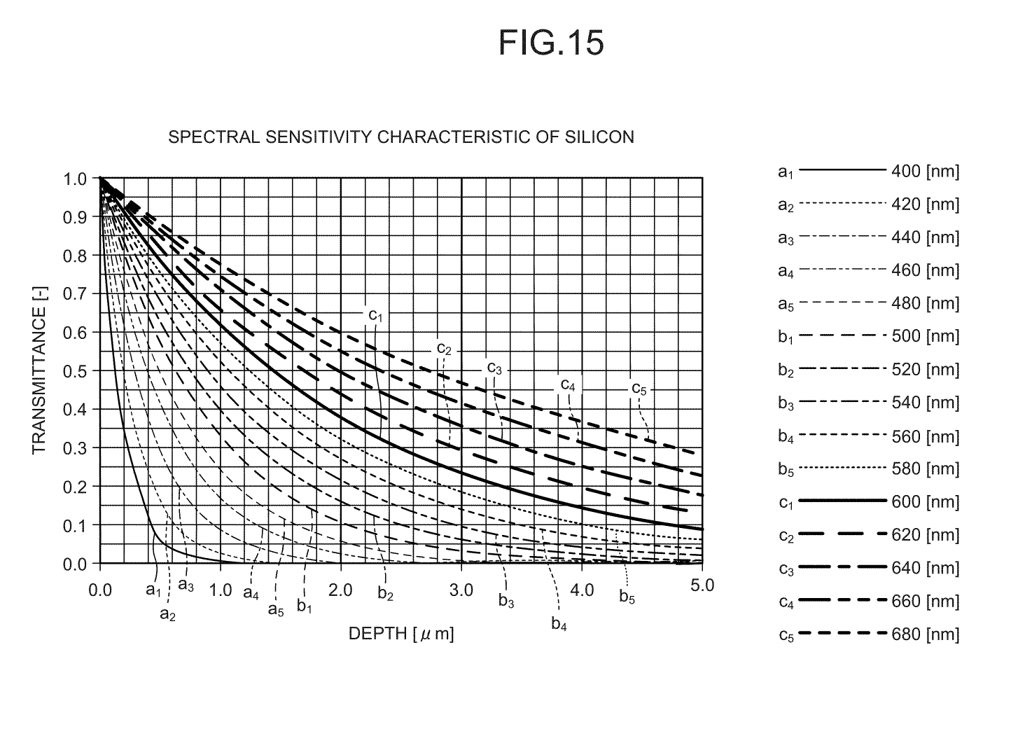

For the solid-state imaging device, photoelectric conversion portions (such as photodiodes) are made by ion-implanting donors (phosphorus, arsenic, etc.) and acceptors (boron, etc.) into a semiconductor substrate SB to form PN junction areas. Because of advances in the semiconductor manufacturing technology in recent years, the shrinkage of pixel sizes has advanced in the development of solid-state imaging devices, so that the unit-pixel size can be made smaller than 1 μm. At this time, as shown in FIGS. 14 and 15, as to photodiodes formed of silicon, it is desired to secure a thickness of about 3 μm to 4 μm for the junction depth of the photodiodes, when considering the penetration length of the absorption of, especially, red light on the longer wavelength side of the visible light region. FIG. 14 is a graph showing the relation between the wavelength of light and the absorption coefficient and penetration length thereof. FIG. 15 is a graph showing the spectral sensitivity characteristic of silicon. Hence, when the shrinkage of the unit-pixel size advances, the aspect ratio (thickness/in-plane width) in the shape of photodiodes in the solid-state imaging device tends to increase, and there is the possibility that optical crosstalk with adjacent pixels may increase to such a level that it cannot be neglected in terms of performance.

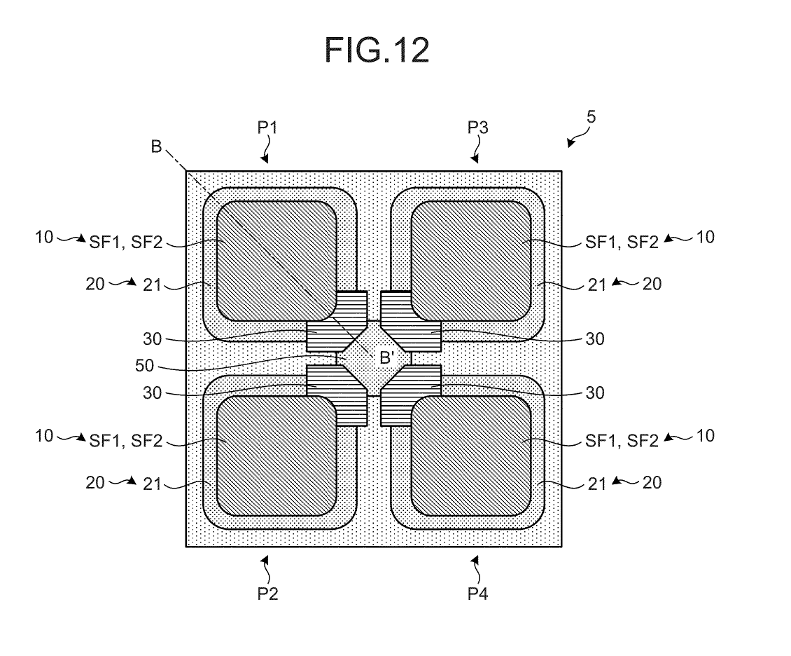

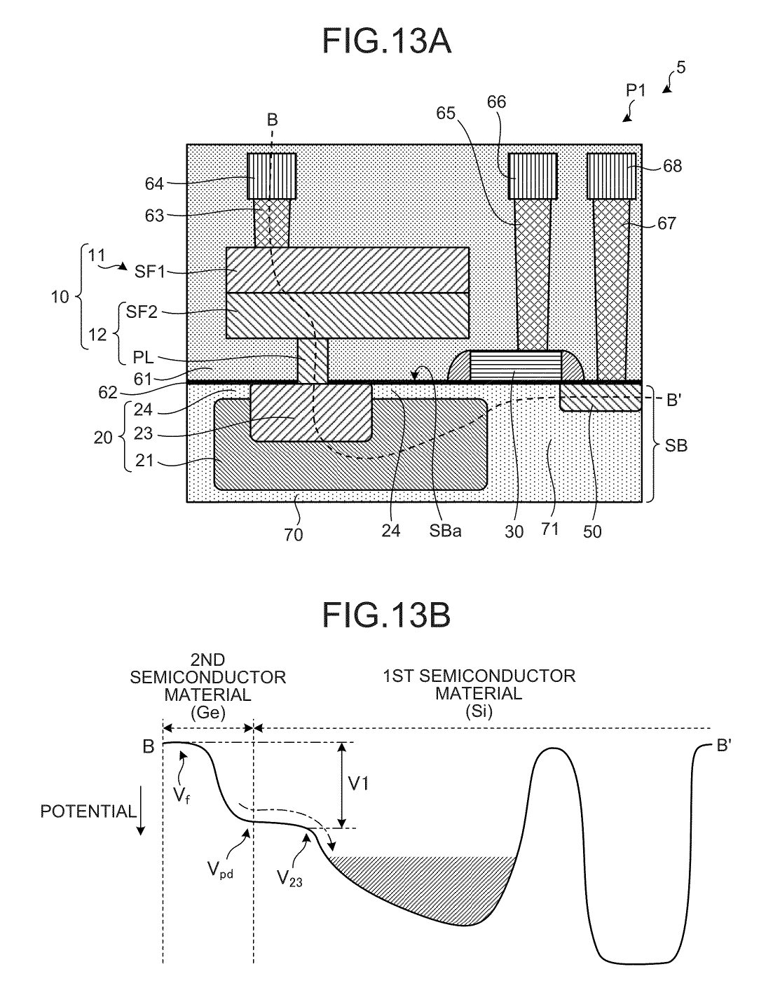

In the basic form, in order to suppress this optical crosstalk, a material having a narrower band gap than silicon is used for the photoelectric conversion portion as shown in FIGS. 12 and 13A. FIG. 12 is a diagram showing the in-plane configuration of a solid-state imaging device 5 according to the basic form. FIG. 13A is a diagram showing the in-cross-section configuration of the solid-state imaging device 5 according to the basic form and illustrates the configuration in a cross-section taken along line B-B′ in the in-plane configuration of FIG. 12.

Specifically, in the solid-state imaging device 5, a plurality of pixels are arranged one-dimensionally or two-dimensionally. For example, in the solid-state imaging device 5, a plurality of pixels P1 to P4 are arranged two-dimensionally as shown in FIG. 12. The pixel P1 of the solid-state imaging device 5 will be described illustratively.

The pixel P1 has a semiconductor region 70, a charge storage portion 20, a photoelectric conversion portion 10, a gate electrode (transfer gate) 30, and a charge-voltage conversion region 50.

The semiconductor region 70 is placed in the semiconductor substrate SB and covers the charge storage portion 20 from below in the semiconductor substrate SB. The semiconductor region 70 is formed of a first semiconductor material containing an impurity of a first conductivity type (e.g., P type) at a low concentration. The P-type impurity is, for example, boron or aluminum.

The charge storage portion 20 is placed in the semiconductor substrate SB. The charge storage portion 20 has a first region 21 of a second conductivity type (e.g., N type), a third region 23 of the second conductivity type, and a fourth region 24 of the first conductivity type (e.g., P type). The second conductivity type is the opposite of the first conductivity type. The first region 21 is formed of the first semiconductor material containing an impurity of the second conductivity type (e.g., N type) at a concentration higher than the concentration of a first-conductivity-type impurity in the semiconductor region 70. The N-type impurity is, for example, phosphorus or arsenic. The third region 23 is placed adjacent to the surface SBa of the semiconductor substrate SB to electrically connect the photoelectric conversion portion 10 to the first region 21. The third region 23 is formed of the first semiconductor material containing an impurity of the second conductivity type at a higher concentration than the first region 21. The fourth region 24 is placed adjacent to the surface SBa of the semiconductor substrate SB to protect the first region 21 at positions adjacent to the third region 23. The fourth region 24 is formed of the first semiconductor material containing an impurity of the first conductivity type at a higher concentration than the semiconductor region 70.

The photoelectric conversion portion 10 has a first portion 11 of the first conductivity type (e.g., P type) and a second portion 12 of the second conductivity type (e.g., N type). The photoelectric conversion portion 10 is, for example, a photodiode.

The first portion 11 includes a semiconductor film SF1. The semiconductor film SF1 is placed in a position over the semiconductor substrate SB that corresponds to the charge storage portion 20. The semiconductor film SF1 is formed of the second semiconductor material containing an impurity of the first conductivity type (e.g., P type) at a higher concentration than the semiconductor region 70. The second portion 12 includes a semiconductor film SF2 and a plug PL. The semiconductor film SF1 is placed on, and covers, the semiconductor film SF2. The semiconductor film SF2 is formed of the second semiconductor material containing an impurity of the second conductivity type (e.g., N type) at a concentration higher than the concentration of the first-conductivity-type impurity in the semiconductor region 70.

The plug PL electrically connects the semiconductor film SF2 to the first region 21 via the third region 23. The plug PL extends through an interlayer insulating film 61 placed between the semiconductor film SF2 and the semiconductor substrate SB and an insulating film 62 covering the surface SBa of the semiconductor substrate SB to connect the semiconductor film SF2 and the third region 23. The interlayer insulating film 61 is formed of a material composed mainly of, e.g., silicon oxide. Thus, the contact area between the first and second semiconductor materials can be reduced as compared with the case where the semiconductor film SF2 is formed immediately above the semiconductor substrate SB, so that defect sites due to a lattice mismatch at the interface between the first and second semiconductor materials can be reduced in number. Further, the plug PL can be configured such that defects occurring at the interface with the semiconductor substrate SB do not reach the semiconductor film SF2. The maximum width of the bottom of the plug PL is less than or equal to 300 nm, for example.

If the maximum width of the bottom of the plug PL is greater than 300 nm, defects due to a lattice mismatch at the interface between the plug PL and the third region 23 may reach the semiconductor films SF1, SF2. Some of defects having reached the semiconductor films SF1, SF2 may become point defects extending into the film grown during crystal growth, and, if a PN junction is formed near the point defects, may become a source of very large dark current.

Meanwhile, in the basic form, the maximum width of the bottom of the plug PL is less than or equal to 300 nm. Thus, crystal defects (dislocations) due to a lattice mismatch between the second semiconductor material that is material for the photoelectric conversion portion 10 and the first semiconductor material that is material for the charge storage portion 20 can be absorbed by the plug PL, so that the crystallinity of the semiconductor films SF2 and SF1 grown thereon can be easily improved.

The plug PL is formed of the second semiconductor material containing an impurity of the second conductivity type at a concentration higher than the concentration of the first-conductivity-type impurity in the semiconductor region 70 and substantially the same as the concentration of the second-conductivity-type impurity in the third region 23, for example.

In the solid-state imaging device 5, the interface between the semiconductor films SF1 and SF2 forms a PN junction area. The photoelectric conversion portion 10 performs photoelectric conversion on light led thereto in the PN junction area to generate an amount of charges according to the light. For example, where the solid-state imaging device 5 is a front-side irradiation type of solid-state imaging device, light is incident from above in FIG. 13A, and most of the incident light can be photoelectrically converted at the interface between the semiconductor films SF1 and SF2 in the photoelectric conversion portion 10. Or where the solid-state imaging device 5 is a back-side irradiation type of solid-state imaging device, light is incident from below in FIG. 13A, and the component having passed through the semiconductor substrate SB of the incident light can be photoelectrically converted at the interface between the semiconductor films SF1 and SF2 in the photoelectric conversion portion 10.

At this time, a reference potential (e.g., ground potential) Vf is supplied to the semiconductor film SF1 of the first portion 11 via a line 64 and a plug 63. The line 64 is formed of a material composed mainly of metal such as Cu or Al, and the plug 63 is formed of a material composed mainly of metal such as tungsten. For example, the line 64 may be electrically connected to a ground line, so that ground potential is supplied as reference potential Vf to the line 64, or the line 64 may be connected to the semiconductor substrate SB via a substrate contact, so that substrate potential is supplied as reference potential Vf to the line 64. As shown in FIG. 13B, the difference between reference potential Vf of the first portion 11 side and a potential V23 of the third region 23, that is, an electric field V1, which increases when going from the first portion 11 toward the third region 23, is applied mainly across the photoelectric conversion portion 10. The potential V23 of the third region 23 is slightly higher than a potential Vpd of the second portion 12 side according to the concentration of the second-conductivity-type impurity in the third region 23. The electric field V1 applied mainly across the photoelectric conversion portion 10 can be expressed by, e.g., the following equation 1.

$$\begin{matrix}V 1 = V 23 - Vf \\ = Vpd + Δ V 23 - Vf\end{matrix} \qquad Equation 1$$

Thus, charges generated in the photoelectric conversion portion 10 is transferred to the charge storage portion 20 side as indicated by a dot-dashed arrow in FIG. 13B. The charge storage portion 20 stores the transferred charges in the first region 21. FIG. 13B is a diagram showing the potential structure of the path along line B-B′ in the cross-section shown in FIG. 13A.

Also, the interface between the first region 21 and the fourth region 24 and the interface between the first region 21 and the semiconductor region 70 in the semiconductor substrate SB form PN junction areas. In these PN junction areas, photoelectric conversion can be performed to generate an amount of charges according to the light. For example, where the solid-state imaging device 5 is a back-side irradiation type of solid-state imaging device, light is incident from below in FIG. 13A, and the incident light can be photoelectrically converted in the PN junction areas in the semiconductor substrate SB. The charge storage portion 20 stores in the first region 21 the charges generated in the PN junction areas in the semiconductor substrate SB.

The gate electrode 30 is placed on the semiconductor substrate SB at a position adjacent to the charge storage portion 20. The gate electrode 30 is formed of, e.g., polysilicon or the like that contains an impurity so as to be conductive. The gate electrode 30, together with the first region 21 in the charge storage portion 20 and the charge-voltage conversion region 50, forms a transfer transistor. When a control signal of an active level is supplied to the gate electrode 30 via a line 66 and a plug 65, this transfer transistor turns on to transfer charges stored in the charge storage portion 20 (e.g., in the first region 21) to the charge-voltage conversion region 50. The line 66 is formed of a material composed mainly of metal such as Cu or Al, and the plug 65 is formed of a material composed mainly of metal such as tungsten.

The charge-voltage conversion region 50 is placed in a well region 71 in the semiconductor substrate SB. The charge-voltage conversion region 50 is formed of the first semiconductor material containing an impurity of the second conductivity type (e.g., N type) at a concentration higher than the concentration of the first-conductivity-type impurity in the well region 71. The charge-voltage conversion region 50 converts charges transferred by the transfer transistor to a voltage. The charge-voltage conversion region 50 is, for example, floating diffusion. An amplifying transistor (not shown) receives the converted voltage via a plug 67 and a line 68 and outputs a signal according to the received voltage onto a signal line. After the signal according to the voltage of the charge-voltage conversion region 50 is output onto the signal line, the voltage of the charge-voltage conversion region 50 can be reset by a resetting transistor (not shown) to a potential according to power supply potential. The line 68 is formed of a material composed mainly of metal such as Cu or Al, and the plug 67 is formed of a material composed mainly of metal such as tungsten.

It should be noted that the charge-voltage conversion region 50 may be shared by a plurality of pixels. For example, as shown in FIG. 12, by providing the charge-voltage conversion region 50 between adjacent corners of four pixels P1 to P4, the four pixels P1 to P4 can share the charge-voltage conversion region 50 while intervals between the four pixels P1 to P4 can be set shorter, resulting in the four pixels P1 to P4 being efficiently laid out.

Because the photoelectric conversion portion 10 is placed over the charge storage portion 20 in each pixel, the placement density of the pixels can be easily improved as compared with the case where the photoelectric conversion portion and the charge storage portion are placed laterally in each pixel. For example, as shown in FIG. 12, when seen through the imaging device in a direction perpendicular to the surface SBa of the semiconductor substrate SB, the semiconductor films SF1 and SF2 each have a shape corresponding to the first region 21 in each pixel P1 to P4. In each pixel P1 to P4, the semiconductor films SF1 and SF2 and the first region 21 each have a substantially rectangular shape. When seen through the imaging device in a direction perpendicular to the surface SBa of the semiconductor substrate SB, the semiconductor films SF1 and SF2 can be each included in the first region 21 in each pixel P1 to P4. Thus, the plurality of pixels P1 to P4 can be placed at intervals corresponding to the size of the photoelectric conversion portion 10 (the first region 21).

The second semiconductor material, shown in FIG. 13B, that is material for the semiconductor films SF1 and SF2 is narrower in band gap and higher in absorption coefficient to visible light than the first semiconductor material that is material for the semiconductor substrate SB. That is, the absorption coefficient to visible light of the material of the semiconductor films SF1 and SF2 is higher than the absorption coefficient to visible light of the material of the semiconductor substrate SB.

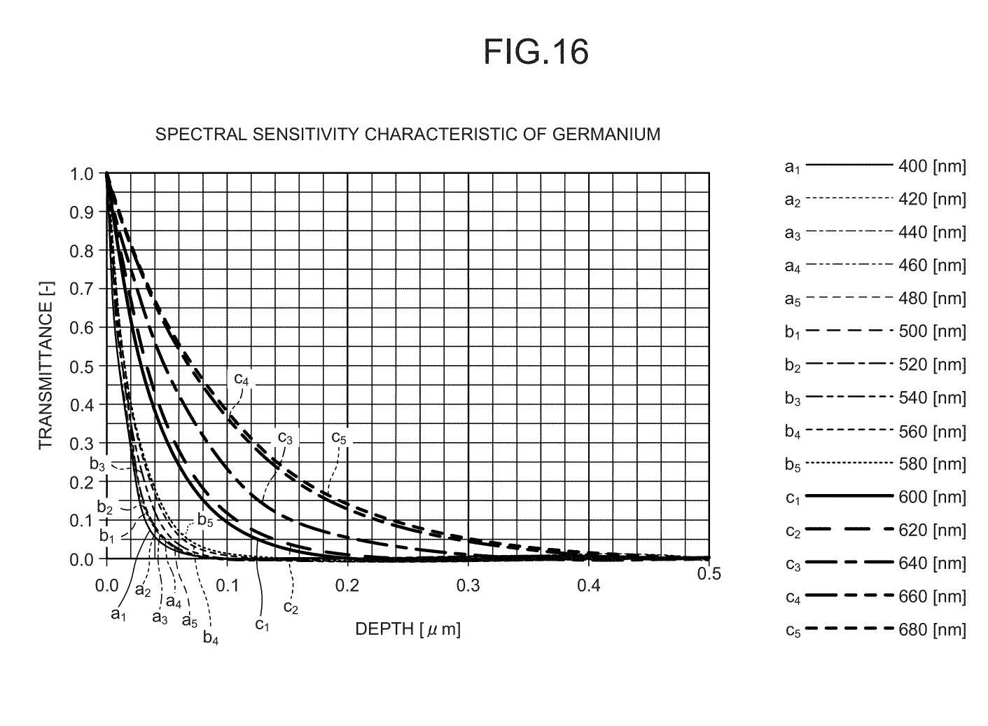

For example, the semiconductor substrate SB is formed of a material composed mainly of silicon, and the semiconductor films SF1 and SF2 are formed of a material composed mainly of Si₁₋ₓGeₓ (0<x≦1). For example, if Si is selected for the material of the semiconductor substrate SB and Si₁₋ₓGeₓ (0<x<1) is selected for the material of the semiconductor films SF1 and SF2, since the absorption coefficient of the semiconductor films SF1 and SF2 is expected to take on a value between the absorption coefficient of Si indicated by a broken line in FIG. 14 and that of Ge indicated by a solid line, the absorption coefficient to visible light of the material of the semiconductor films SF1 and SF2 will be higher than the absorption coefficient to visible light of the material of the semiconductor substrate SB. Or, for example, if Si is selected for the material of the semiconductor substrate SB and Ge is selected for the material of the semiconductor films SF1 and SF2, since the absorption coefficient of Ge indicated by the solid line in FIG. 14 is greater than that of Si indicated by the broken line, the absorption coefficient to visible light of the material of the semiconductor films SF1 and SF2 will be even higher than the absorption coefficient to visible light of the material of the semiconductor substrate SB. Also when comparing the spectral sensitivity characteristics of FIGS. 15 and 16 in the visible light region (400 nm to 700 nm in wavelength), it is seen that the absorption coefficient to visible light of the material (Ge) of the semiconductor films SF1 and SF2 is even higher than the absorption coefficient to visible light of the material (Si) of the semiconductor substrate SB. FIG. 16 is a graph showing the spectral sensitivity characteristic of germanium.

That is, if Si is selected for the material of the semiconductor substrate SB and Ge or Si₁₋ₓGeₓ (0<x<1) is selected for the material of the semiconductor films SF1 and SF2, respective thicknesses of the semiconductor films SF1 and SF2 can be set as small as, e.g., about 0.1 μm to 0.5 μm and the total thickness of the semiconductor films SF1 and SF2 can be as small as about 0.2 μm to 1.0 μm, while securing photoelectric conversion efficiency satisfying the requirement. Thus, the total thickness of the photoelectric conversion portion 10 and the charge storage portion 20 can be set smaller, hence suppressing light having obliquely entered the pixel P1 from entering an adjacent pixel. That is, color mixing between adjacent pixels due to obliquely incident light can be suppressed.

It should be noted that, where Ge is selected for the material of the semiconductor films SF1 and SF2, a lattice mismatch with the semiconductor substrate SB occurs because of the difference between the lattice constant of 0.565 nm of Ge and the lattice constant of 0.543 nm of Si. Where Si₁₋ₓGeₓ (0<x<1) is selected for the material of the semiconductor films SF1 and SF2, a lattice mismatch with the semiconductor substrate SB occurs because the average crystal lattice interval takes on a value between the lattice constants of 0.543 nm and 0.565 nm of Si and Ge. At this time, because the crystal orientation limits the direction in which a point defect grows in crystal growth of Ge or Si₁₋ₓGeₓ (0<x<1), by setting the maximum width of the bottom of the plug PL less than or equal to, e.g., 300 nm, stress due to the lattice mismatch can be lessened, and crystal defects (dislocations) due to the lattice mismatch can be absorbed in the plug PL, so that the crystallinity of the semiconductor films SF2 and SF1 grown thereon can be easily improved. Thus, the degradation in crystallinity of the semiconductor films SF1 and SF2 can be suppressed, and photoelectric conversion efficiency in the semiconductor films SF1 and SF2 can be easily improved.

Meanwhile, when the semiconductor films SF1 and SF2 are formed of the second semiconductor material, dark current tends to increase as compared with the case where the semiconductor films SF1 and SF2 are formed of the first semiconductor material.

The dark current refers to current represented as the sum of a diffusion (drift) term (first term on the right hand side) of minority carriers flowing into the PN junction area of the photodiode and a generation current term (second term on the right hand side) due to traps in the PN junction area as expressed by the following equation 2.

$$\begin{matrix}{J}_{rev} = {J}_{diff} + {J}_{GR} \\ = q √ ( D / τ ) \times {n}_{i}^{2} / {N}_{dope} + {qn}_{i} W / {τ}_{g} \\ = ( minority carrier diffusion term ) + \\ ( trap \text{-} induced generation current term )\end{matrix} \qquad Equation 2$$

In Equation 2, q is the elementary charge, D and τ are the diffusion coefficient and diffusion lifetime of minority carriers, nᵢ is the intrinsic carrier concentration, N_{dope} is the impurity concentration of a region as a minority carrier source, W is the depletion layer width of the PN junction, and τ_{g} denotes the generation time of generation current generated via traps (or lifetime of carriers captured in traps). For Equation 2, it is assumed that the entire photodiode is made of the same material and that the magnitude relation holds where acceptor concentration N_{A} of the anode electrode side in the photodiode>>donor concentration N_{D} of the cathode electrode side.

Note that letting the diffusion relaxation time and momentum relaxation time be the same, among the diffusion coefficient D, a diffusion length L, the diffusion lifetime τ, and effective mass m* of the minority carrier, the equation 3 holds:

D=μk_{B}T/q=qτ/m*×k_{B}T/q, L=√(Dτ). Equation 3

With this, the term of minority carrier diffusion, the first term, of Equation 2 is rewritten as follows:

$$\begin{matrix}{J}_{diff} = q \times {D}_{p} / {L}_{p} \times {n}_{i}^{2} / {N}_{D} + q \times {D}_{n} / {L}_{n} \times {n}_{i}^{2} / {N}_{A} \\ = q \{ \begin{matrix}√ ( {k}_{B} T / m {*}_{p} ) \times {n}_{i}^{2} / {N}_{D} + \\ √ ( {k}_{B} T / m {*}_{n} ) \times {n}_{i}^{2} / {N}_{A}\end{matrix} \} .\end{matrix} \qquad Equation 4$$

Here, k_{B} is Boltzmann constant, and T is the operating temperature. The subscripts n, p denote electrons and holes respectively.

Also, note that the intrinsic carrier concentration nᵢ has a relation with the band gap Eg expressed by the following equation 5.

nᵢ∝exp(−E_{g}/(2k_{B}T)) Equation 5

That is, if the semiconductor films SF1 and SF2 of the photoelectric conversion portion 10 are formed of the second semiconductor material (e.g., Si₁₋ₓGeₓ, 0<x≦1) having a narrower band gap Eg than the first semiconductor material (Si), then in the semiconductor film SF1, the effective mass m* of the carrier becomes smaller, and the intrinsic carrier concentration nᵢ increases, so that the dark current component J_{diff} due to the diffusion of minority carriers expressed by Equation 4 is likely to take on a large value. Thus, dark current tends to increase as compared with the case where the semiconductor films SF1 and SF2 are formed of the first semiconductor material.

Because a relatively large electric field V1 is applied across the photoelectric conversion portion 10 as shown in FIG. 13B, the charges of the dark current component in the photoelectric conversion portion 10 easily flows into the charge storage portion 20, and hence the proportion of the charges of the dark current component to the signal charges stored in the charge storage portion 20 is likely to increase. Thus, the S/N ratio of the pixel signal read out from each pixel of the solid-state imaging device 5 is likely to degrade, and the quality of an image obtained from the image signal read out from the solid-state imaging device 5 may degrade.

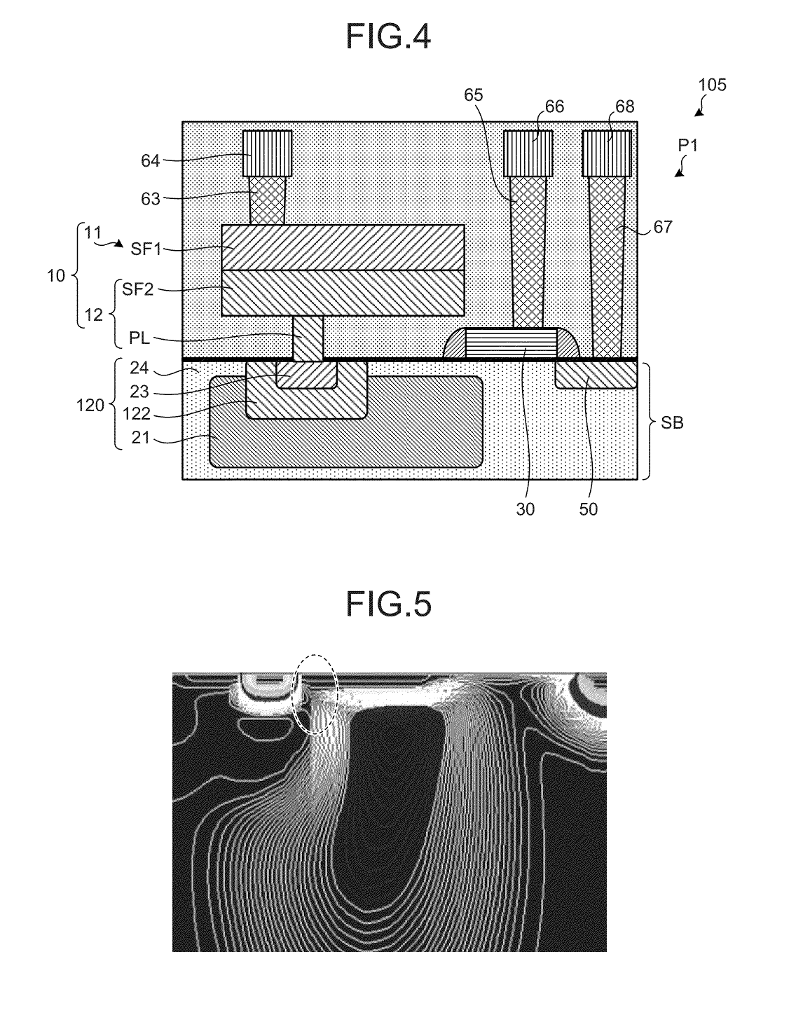

Accordingly, in the present embodiment, as shown in FIG. 4, a charge storage portion 120 is configured such that an overflow potential is formed in the connection area with the photoelectric conversion portion 10 in a solid-state imaging device 105, and charges can overflow into the charge storage portion 120 in response to incident light, thereby achieving both an improvement in photoelectric conversion efficiency and the suppression of dark current. FIG. 4 is a diagram showing the in-cross-section configuration of the solid-state imaging device 105. Description below will be centered on differences from the basic form.

Specifically, pixel P1 has the charge storage portion 120 instead of the charge storage portion 20 (see FIG. 13A). The charge storage portion 120 is configured such that the overflow potential is formed in the connection area with the photoelectric conversion portion 10. The overflow potential is a barrier potential formed so that charges generated in the photoelectric conversion portion 10 in response to incident light can overflow the barrier potential to the charge storage portion 120. The overflow potential is a potential between the reference potential and power supply potential. The reference potential is supplied to the semiconductor film SF1 via the line 64 and the plug 63 and is, for example, ground potential. The power supply potential is a potential used when resetting the voltage of the charge-voltage conversion region 50 through a reset transistor (not shown) after a signal according to the voltage of the charge-voltage conversion region 50 is output onto a signal line. The overflow potential is closer to the reference potential than an intermediate potential between the reference potential and power supply potential.

The charge storage portion 120 further has a second region 122 as well as the first region 21, the third region 23, and the fourth region 24. The second region 122 is placed between the second portion 12 and the first region 21 and forms an overflow potential in the connection area with the photoelectric conversion portion 10 in the semiconductor substrate SB. For example, the second region 122 is placed between the third region 23 and the first region 21 in the semiconductor substrate SB and forms an overflow potential between the third region 23 and the first region 21 in the semiconductor substrate SB. The second region 122 is formed of the first semiconductor material containing a first-conductivity-type impurity. The second region 122 contains, e.g., a first-conductivity-type impurity at a lower concentration than the fourth region 24.

For example, the second region 122 contains a first-conductivity-type impurity at a concentration corresponding to the overflow potential. The width along a direction of the path through which charges flow of the second region 122 corresponds to the overflow potential. That is, the overflow potential formed by the second region 122 can be adjusted through the concentration of the first-conductivity-type impurity in the second region 122 and the width along a direction of the path through which charges flow of the second region 122. For example, in order to obtain a desired overflow potential, the width along a direction of the path through which charges flow of the second region 122 can be set at a first width when the concentration of the first-conductivity-type impurity in the second region 122 is set at a first concentration. Or, for example, in order to obtain a desired overflow potential, the concentration of the first-conductivity-type impurity in the second region 122 can be set at a second concentration lower than the first concentration when the width along a direction of the path through which charges flow of the second region 122 is set at a second width larger than the first width. Or, for example, in order to obtain a desired overflow potential, the width along a direction of the path through which charges flow of the second region 122 can be set at a third width smaller than the first width when the concentration of the first-conductivity-type impurity in the second region 122 is set at a third concentration higher than the first concentration.

In the solid-state imaging device 105, the charges of dark current generated in the photoelectric conversion portion 10 can be blocked by the overflow potential formed by the second region 122, thus being suppressed from flowing into the first region 21. For example, for the state of the transfer transistor being off which is formed of the gate electrode 30, the first region 21, and the charge-voltage conversion region 50, calculating a potential distribution in the in-cross-section configuration shown in FIG. 4 produced the result shown in FIG. 5. FIG. 5 is an example potential cross-sectional view calculated in simulation. As marked with an enclosing broken line in FIG. 5, it is found out that the overflow potential higher to some degree than in the vicinity is formed by the second region 122.

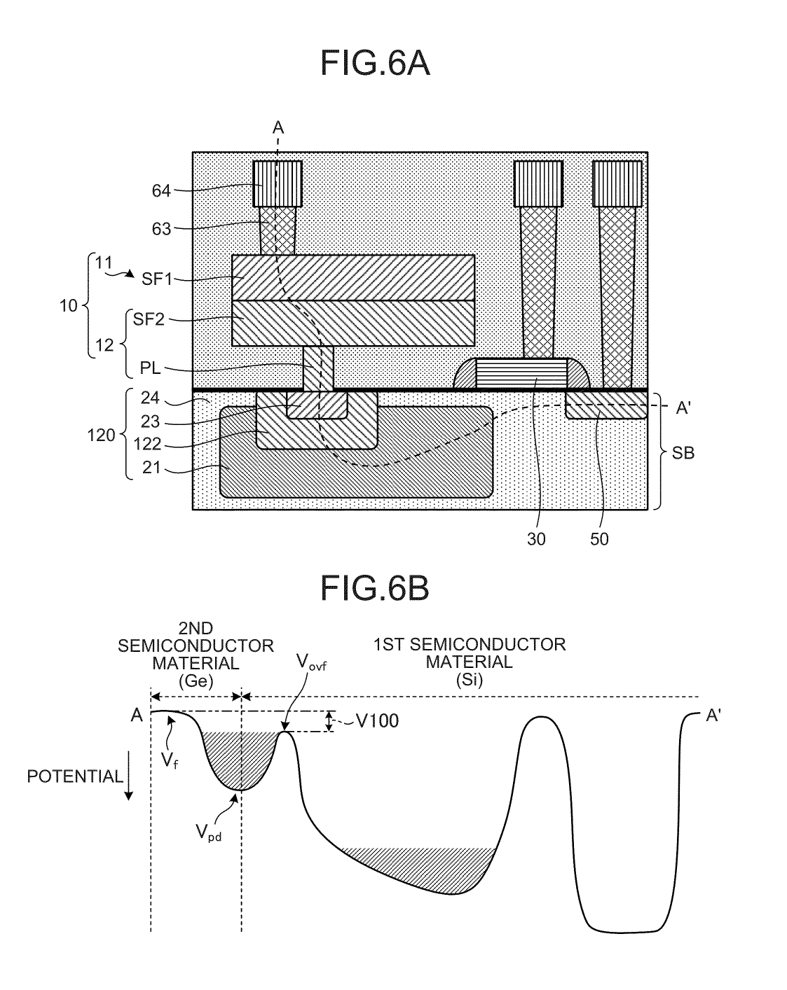

At this time, reference potential (e.g., ground potential) Vf is supplied to the semiconductor film SF1 of the first portion 11 via the line 64 and the plug 63. As shown in FIG. 6B, an electric field V100 that is the difference between reference potential Vf of the first portion 11 side and the potential (overflow potential) Vovf of the second region 122, which field increases when going from the first portion 11 toward the second region 122, is applied mainly across the photoelectric conversion portion 10. The overflow potential Vovf formed by the second region 122 is considerably lower than the potential Vpd of the second portion 12 side according to the concentration of the first-conductivity-type impurity in the second region 122 and the width along the path of charges of the second region 122. The electric field V100 applied mainly across the photoelectric conversion portion 10 can be expressed by, e.g., the following equation 6.

$$\begin{matrix}V 100 = Vovf - Vf \\ = Vpd - Δ V 122 - V f\end{matrix} \qquad Equation 6$$

From Equations 1, 6, the difference between the electric field V100 and the electric field V1 of the basic form (see FIG. 13B) can be expressed by the following equation 7.

V100−V1=−ΔV122−ΔV23(ΔV122, ΔV23 are positive values) Equation 7

As shown in Equation 7, it is seen that the electric field V100 applied mainly across the photoelectric conversion portion 10 can be greatly reduced as compared with the electric field V1 of the basic form. Therefore, it is seen that the charges of dark current generated in the photoelectric conversion portion 10 can be blocked by the overflow potential Vovf formed by the second region 122, and thus can be suppressed from flowing into the first region 21. FIG. 6A is a diagram showing the same in-cross-section configuration as FIG. 4, and FIG. 6B is a diagram showing the potential structure of the path along line A-A′ in the cross-section shown in FIG. 6A.

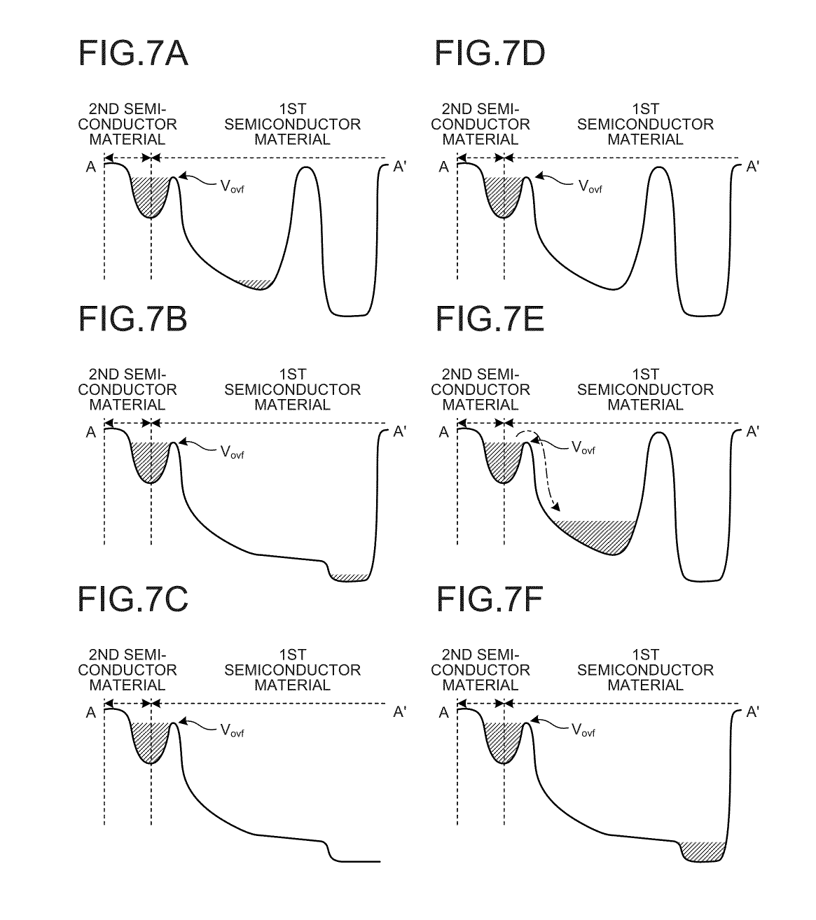

Next, the operation of each pixel in the solid-state imaging device 105 will be described using FIGS. 7A to 7F. FIGS. 7A to 7F are diagrams showing potential structures similar to that of FIG. 6B in the operation of the solid-state imaging device 105.

At the timing shown in FIG. 7A, the second portion 12 and the third region 23 are adjusted to be at substantially the same potential as the overflow potential Vovf, in a self-matching manner by the signal having undergone exposure and photoelectric conversion before electronic shuttering, and dark current. Because the overflow potential Vovf is adjusted to be higher to some degree than the reference potential (e.g., ground potential), the photoelectric conversion portion 10 formed of the second semiconductor material having a narrower band gap can be prevented from being applied a strong electric field across, thus suppressing an increase in dark current. By increasing the impurity concentration in the vicinity of the interface between the semiconductor films SF1 and SF2, the capture cross-section area of interface defects can be decreased, thus suppressing signal loss due to defects (e.g., to a minimum). That is, charges of dark current generated in the photoelectric conversion portion 10 can be made to stay in the second portion 12 and the third region 23. Further, charges of dark current generated in the semiconductor substrate SB is held in the first region 21.

In the present embodiment, in order to discard redundant charges before signal storage so as to obtain a desired signal in the photoelectric conversion portion 10, an operation called electronic shuttering is performed which applies high voltages to the charge-voltage conversion region 50 and the gate electrode 30 to discharge redundant charges from the first region 21.

For example, at the timing shown in FIG. 7B, a control signal of an active level is applied to the gate electrode 30 to turn on the transfer transistor formed by the gate electrode 30, the first region 21, and the charge-voltage conversion region 50. Thus, charges of dark current held in the first region 21 are transferred to the charge-voltage conversion region 50.

At the timing shown in FIG. 7C, the voltage of the charge-voltage conversion region 50 is reset to a voltage according to power supply potential through a reset transistor (not shown). Thus, charges of dark current transferred to the charge-voltage conversion region 50 are discharged to the power supply potential side.

In the electronic shuttering operation, since being substantially fixed at close to the reference potential (e.g., ground potential), the overflow potential Vovf almost does not vary, and the connection area between the second and first semiconductor materials is hardly likely to be influenced by the electronic shuttering operation. After the first region 21 is completely depleted by the electronic shuttering operation, the charge storage operation by the charge storage portion 120 is started.

For example, at the timing shown in FIG. 7D, the control signal of a non-active level is applied to the gate electrode 30 to turn off the transfer transistor formed by the gate electrode 30, the first region 21, and the charge-voltage conversion region 50. Thereby, the charge storage operation by the charge storage portion 120 is started.

At the timing shown in FIG. 7E, when light is incident on the pixel, photoelectric conversion is performed in the PN junction area in the photoelectric conversion portion 10 and/or the PN junction area in the semiconductor substrate SB. At this time, charges generated in the photoelectric conversion portion 10 formed of the second semiconductor material having a narrower band gap flow into the third region 23, and because the potential of the third region 23 is substantially the same potential as the overflow potential Vovf, charges having flowed into the third region 23 flow from the third region 23 over the overflow potential Vovf into the first region 21 as indicated by a dot-dashed arrow. The charges having flowed into the first region 21, together with charge generated by photoelectric conversion in the semiconductor substrate SB, are stored as signal charges in the first region 21.

At the timing shown in FIG. 7F, the control signal of the active level is applied to the gate electrode 30 to turn on the transfer transistor formed of the gate electrode 30, the first region 21, and the charge-voltage conversion region 50. Thereby, the charge storage operation by the charge storage portion 120 finishes, and the signal charges stored in the first region 21 is transferred to the charge-voltage conversion region 50.

In the present embodiment, with the above configuration, the second semiconductor material having a narrower band gap can be used for the photoelectric conversion portion 10 without bothering with dark current. With the structure of the present embodiment, by setting the film thickness of the photoelectric conversion portion 10 formed of the second semiconductor material having a narrower band gap such as germanium at a certain level of thickness, the thickness of the semiconductor substrate SB formed of the first semiconductor material can be reduced without causing a reduction in sensitivity, or rather with an improvement in the sensitivity of the device. By reducing the thickness of the semiconductor substrate SB, the aspect ratio of thickness to width in the shape of the photodiode can be lowered, thus providing the solid-state imaging device 105 that can be resistant to optical crosstalk. Further, by suppressing the film thickness of photodiodes to be formed on the semiconductor substrate SB to about 1 μm, a change from a special semiconductor process used to form photodiodes having a film thickness as thick as about 3 μm to a general-purpose process using resists and lithography can be made, thus reducing the production cost of the solid-state imaging device 105.

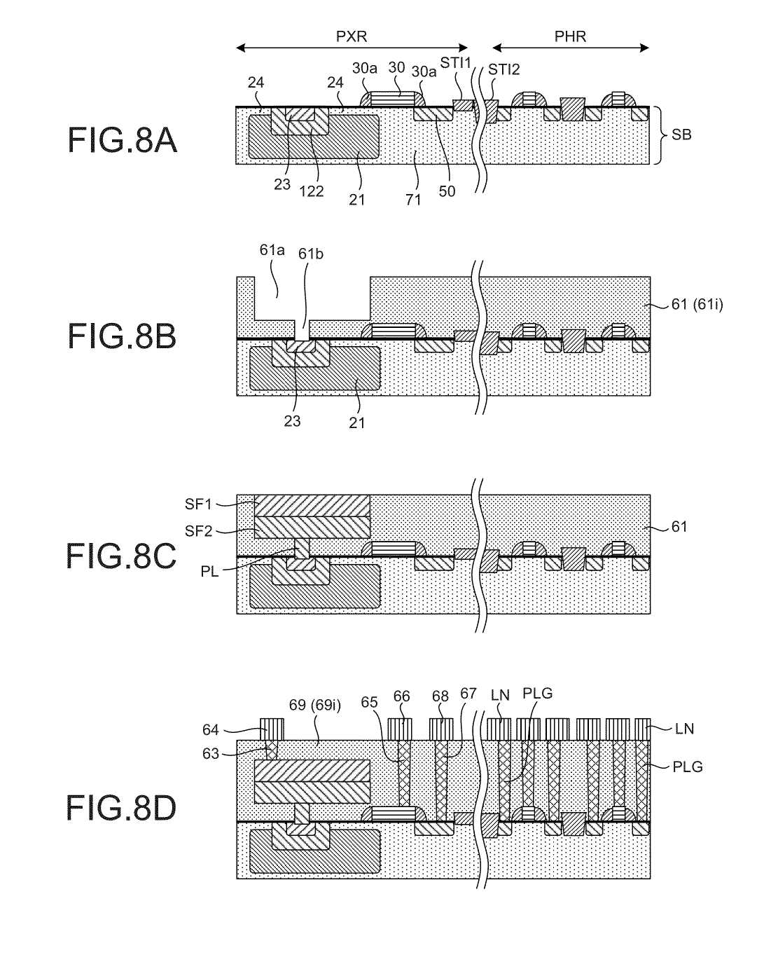

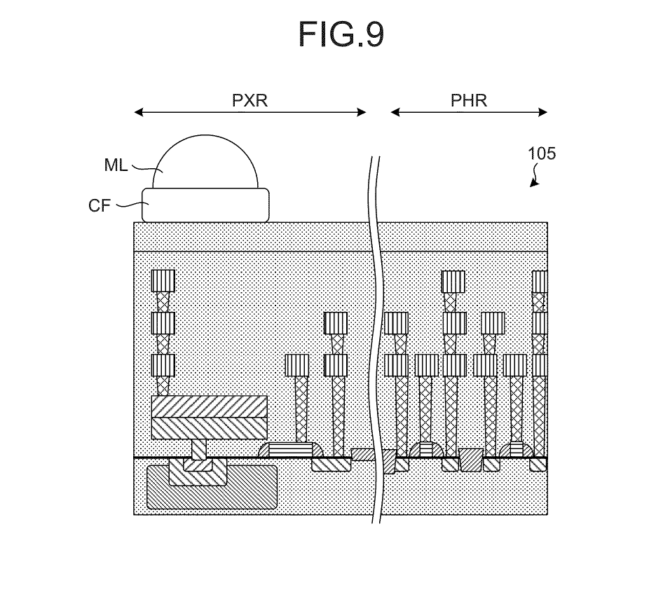

Next, the manufacturing method of the solid-state imaging device 105 will be described using FIGS. 8A to 8D and 9. FIGS. 8A to 8D and 9 are process step cross-sectional views showing the manufacturing method of the solid-state imaging device 105. FIGS. 8A to 8D and 9 illustrate the case where the solid-state imaging device 105 is a front-side irradiation type of solid-state imaging device.

In the step shown in FIG. 8A, the semiconductor substrate SB formed of the first semiconductor material (e.g., silicon) is prepared. Then trenches are formed to have predetermined depths in the semiconductor substrate SB using a hard mask, and an insulating substance (e.g., silicon oxide) is filled in the trenches, thereby forming element isolating portions STI1, STI2 in a pixel region PXR and a peripheral circuit region PHR respectively. The pixel region PXR is a region where a pixel array PA (see FIG. 3) is placed in the solid-state imaging device 105. The peripheral circuit region PHR is a region where the vertical shift register 93, timing control unit 95, correlated double sampling unit (CDS) 96, analog-to-digital converter (ADC) 97, and line memory 98 are placed in the solid-state imaging device 105. The element isolating portions STI1 electrically and optically isolates a plurality of pixels from each other in the pixel region PXR. The element isolating portions STI2 electrically isolates a plurality of elements (transistors, etc.) from each other in the peripheral circuit region PHR.

The element isolating portions STI1 of the pixel region PXR can be of substantially the same depth as the element isolating portions STI2 of the peripheral circuit region PHR or can be shallower in depth than the element isolating portions STI2 of the peripheral circuit region PHR. For example, the element isolating portions STI1 of the pixel region PXR can be about 20 to 50 nm thick, and the element isolating portions STI2 of the peripheral circuit region PHR can be set to be about 100 to 300 nm deep. After the element isolating portions STI1, STI2 are formed, well regions of the first conductivity type (e.g., P type) and well regions of the second conductivity type (e.g., N type) are formed in desired areas in the peripheral circuit region PHR using lithography and ion implantation. Well regions of the first conductivity type (e.g., P type) for pixel transistors, first regions 21 of the second conductivity type (e.g., N type), second regions 122 of the first conductivity type, third regions 23 of the second conductivity type, and fourth regions 24 of the first conductivity type are formed in the pixel region PXR.

At this time, conditions for ion implantation are adjusted such that the concentration of the first-conductivity-type impurity in the second region 122 and the width along a direction of the path through which charges flow of the second region 122 become those corresponding to the overflow potential to be formed by the second region 122. That is, respective dose amounts (implantation amounts) and accelerating voltages (implantation depths) for the first regions 21, second regions 122, third regions 23, and fourth regions 24 are adjusted such that the concentration of the first-conductivity-type impurity in the second region 122 and the width along a direction of the path through which charges flow of the second region 122 become those corresponding to the overflow potential to be formed by the second region 122.

The formation of the second regions 122 of the first conductivity type to form the overflow potential can be performed simultaneously with the formation of the well regions of the first conductivity type for pixel transistors. In ion implantation for photodiodes, usually a thick hard mask is necessary to prevent highly-accelerated ions from entering areas other than desired areas, but because with the structure of the present embodiment the thickness of the photodiodes can be set smaller, the photodiodes (charge storage portion) can be formed by the process using lithography and ion implantation, that is, a simple process. Then a gate insulating film of silicon oxide or the like is formed on the semiconductor substrate SB using a process such as thermal oxidation or ALD, and a gate electrode film is deposited using a CVD method or the like. Material such as polysilicon can be used for the gate electrode film. After gate electrodes 30 are formed by processing the gate electrode film by dry etching or the like, an insulating film is deposited using a CVD method or the like, and gate sidewalls of an oxide film 30a are formed using wet etching or dry etching.

In the step shown in FIG. 8B, an interlayer insulating film 61i is deposited on the semiconductor substrate SB by a CVD method or the like, and recesses 61a are formed in areas directly above the first regions 21 where to grow the semiconductor films SF1 and SF2, and holes 61b are formed in areas where to grow plugs PL. The holes 61b are formed extending from the bottoms of the recesses 61a through the interlayer insulating film 61 so as to expose the surfaces of the third regions 23.

In the step shown in FIG. 8C, the plugs PL are grown in the holes 61b in the interlayer insulating film 61 by an epitaxial growth method or the like. The plugs PL are formed of the second semiconductor material containing an impurity of the second conductivity type (e.g., N type). At this time, the growth temperature is preferably, for example, around 700° C.

Here, where, e.g., Si₁₋ₓGeₓ (0<x<1) is selected as the material for the plugs PL, a mixture gas of Si-based gas (e.g., SiH₄) and Ge-based gas (e.g., GeH₄) is used. At this time, the flow ratio of Si-based gas (e.g., SiH₄) to Ge-based gas (e.g., GeH₄) is adjusted according to the composition ratio of Si₁₋ₓGeₓ (0<x<1) to be formed. The second-conductivity-type impurity may be introduced by ion implantation or using gas containing an impurity of a desired conductivity type during the growth of the above semiconductor layer so as to be introduced in situ. Where, e.g., Ge is selected as the material for the plugs PL, epitaxial growth can be performed using a mixture gas of Ge-based gas and gas for introducing a second-conductivity-type impurity in situ.

Then the semiconductor film SF2 is grown in the recesses 61a in the interlayer insulating film 61 by an epitaxial growth method or the like. The semiconductor film SF2 is formed of the second semiconductor material containing an impurity of the second conductivity type (e.g., N type). At this time, the growth temperature is preferably, for example, around 700° C. Where, e.g., Si₁₋ₓGeₓ (0<x≦1) is selected as the material for the semiconductor film SF2, epitaxial growth may be performed using the same gas as in plug PL growth.

Then the semiconductor film SF1 is grown on the semiconductor film SF2 in the recesses 61a in the interlayer insulating film 61 by an epitaxial growth method or the like. The semiconductor film SF1 is formed of the second semiconductor material containing an impurity of the first conductivity type (e.g., P type). At this time, the growth temperature is preferably, for example, around 700° C.

Here, where, e.g., Si₁₋ₓGeₓ (0<x<1) is selected as the material for the semiconductor film SF1, a mixture gas of Si-based gas (e.g., SiH₄) and Ge-based gas (e.g., GeH₄) is used. At this time, the flow ratio of Si-based gas (e.g., SiH₄) to Ge-based gas (e.g., GeH₄) is adjusted according to the composition ratio of Si₁₋ₓGeₓ (0<x<1) to be formed. The first-conductivity-type impurity may be introduced by ion implantation or using gas containing an impurity of a desired conductivity type during the growth of the above semiconductor layer so as to be introduced in situ. Where, e.g., Ge is selected as the material for the semiconductor film SF1, epitaxial growth can be performed using a mixture gas of Ge-based gas and gas for introducing a first-conductivity-type impurity in situ.

It should be noted that the growth of the plugs PL, the growth of the semiconductor film SF2, and the growth of the semiconductor film SF1 may be performed consecutively and sequentially, or, after flattening is performed by CMP subsequent to the growth of the plugs PL, the growth of the semiconductor film SF2 and the growth of the semiconductor film SF1 may be performed sequentially. Where, after flattening is performed by CMP subsequent to the growth of the plugs PL, the growth of the semiconductor film SF2 and the growth of the semiconductor film SF1 are performed sequentially, the crystallinity of the semiconductor films SF2, SF1 can be easily improved.

Subsequently, the interlayer insulating film 61 and the semiconductor film SF1 are flattened by CMP.

In the step shown in FIG. 8D, an interlayer insulating film 69i is deposited and holes are formed using lithography and dry etching. A conductive substance is filled in the holes using sputtering and CMP to form plugs 63, 65, 67, PLG. Then lines 64, 66, 68, LN are formed using sputtering, lithography, and dry etching.

In the step shown in FIG. 9, after undergoing a general-purpose multi-layered line layer forming process, color filters CF using organic pigment are formed in the pixel region PXR, and micro-lenses ML are formed. Thus, the front-side irradiation type of solid-state imaging device 105 adapted for the applications is finished.

As described above, in the present embodiment, in each pixel of the solid-state imaging device 105, the charge storage portion 120 forms an overflow potential in the connection area with the photoelectric conversion portion 10 so that charges generated in the photoelectric conversion portion 10 in response to incident light can overflow into the charge storage portion 120. In the charge storage portion 120, the second regions 122 is placed, e.g., between the second portion 12 and the first region 21 and forms the overflow potential. The first region 21 stores charges having overflowed the overflow potential from the second portion 12. Hence, the charges of dark current generated in the photoelectric conversion portion 10 can be blocked by the overflow potential and can be suppressed from flowing into the first region 21, and the imaging device can have signal charges generated in the photoelectric conversion portion 10 in response to incident light overflow the overflow potential from the second portion 12 to be stored in the first region 21. As a result, both an improvement in photoelectric conversion efficiency in the photoelectric conversion portion 10 and the suppression of dark current in the charge storage portion 120 can be achieved.

In the embodiment, in each pixel of the solid-state imaging device 105, the second regions 122 contains a first-conductivity-type impurity at a concentration corresponding to the overflow potential. The width along a direction of the path through which charges flow of the second region 122 corresponds to the overflow potential. Thus, the overflow potential to be formed in the second regions 122 can be adjusted. It is easy to adjust the overflow potential to be, for example, closer to the reference potential than an intermediate potential between the reference potential and power supply potential.

Further, in the embodiment, in each pixel of the solid-state imaging device 105, the plug PL electrically connects the semiconductor film SF2 to the second region 122 via the third region 23. The plug PL can be configured such that defects occurring at its interface with the semiconductor substrate SB do not reach the semiconductor film SF2. The plug PL, the maximum width of whose bottom is less than or equal to, e.g., 300 nm, can lessen stress due to the lattice mismatch at its interface between the plug PL and the semiconductor substrate SB, in the plug PL, and hence crystal defects (dislocations) due to the lattice mismatch can be absorbed by the plug PL, so that the crystallinity of the semiconductor films SF2 and SF1 grown thereon can be easily improved. Thus, the degradation in crystallinity of the semiconductor films SF1, SF2 can be suppressed, and photoelectric conversion efficiency in the semiconductor films SF1, SF2 can be easily improved.

Yet further, in the embodiment, in each pixel of the solid-state imaging device 105, the photoelectric conversion portion 10 is placed over the charge storage portion 120. When seen through the imaging device in a direction perpendicular to the surface SBa of the semiconductor substrate SB, the semiconductor films SF1 and SF2 each have a shape corresponding to the first region 21. When seen through the imaging device in a direction perpendicular to the surface SBa of the semiconductor substrate SB, the semiconductor films SF1 and SF2 are each included in the first region 21. Thus, the placement density of a plurality of pixels can be easily improved, and hence the plurality of pixels can be laid out efficiently.

It should be noted that, although the above embodiment illustratively describes the case where the second region 122 in the charge storage portion 120 of each pixel is a semiconductor region containing a first-conductivity-type impurity, the second region 122 may be an intrinsic semiconductor region, or may be a semiconductor region containing a second-conductivity-type impurity at a lower concentration than both the second portion 12 and the first region 21 as long as the second region 122 can form a desired overflow potential Vovf (see FIG. 6B).

Or when seen through the imaging device in a direction perpendicular to the surface SBa of the semiconductor substrate SB, if the semiconductor films SF1 and SF2 each have a shape corresponding to the first region 21, then the semiconductor films SF1 and SF2 may be each configured to include the first region 21. In this case, a plurality of pixels can be placed at intervals corresponding to the size of the semiconductor films SF1, SF2, and hence the plurality of pixels can be laid out efficiently.

Although the above embodiment illustratively describes the case where the first conductivity type is the P type and the second conductivity type is the N type, the first conductivity type may be the N type and the second conductivity type may be the P type.

Further, the semiconductor substrate SB may be formed of a material composed mainly of Ge, and the semiconductor films SF1, SF2 and plugs PL may be formed of a material composed mainly of Ge_{1-y}(InGaAs)_{y} (0<y≦1). For example, if Ge is selected as the material for the semiconductor substrate SB, and Ge_{1-y}(InGaAs)_{y} (0<y<1) is selected as the material for the semiconductor films SF1, SF2 and plugs PL, since their absorption coefficient is expected to take on a value between the absorption coefficient of Ge indicated by a solid line in FIG. 14 and that of InGaAs indicated by a dot-dashed line, the absorption coefficient to visible light of the material of the semiconductor films SF1 and SF2 will be higher than the absorption coefficient to visible light of the material of the semiconductor substrate SB. Or, for example, if Ge is selected as the material for the semiconductor substrate SB, and InGaAs is selected as the material for the semiconductor films SF1, SF2 and plugs PL, since the absorption coefficient of InGaAs indicated by a dot-dashed line in FIG. 14 is greater than that of Ge indicated by a solid line, the absorption coefficient to visible light of the material of the semiconductor films SF1 and SF2 will be even higher than the absorption coefficient to visible light of the material of the semiconductor substrate SB.

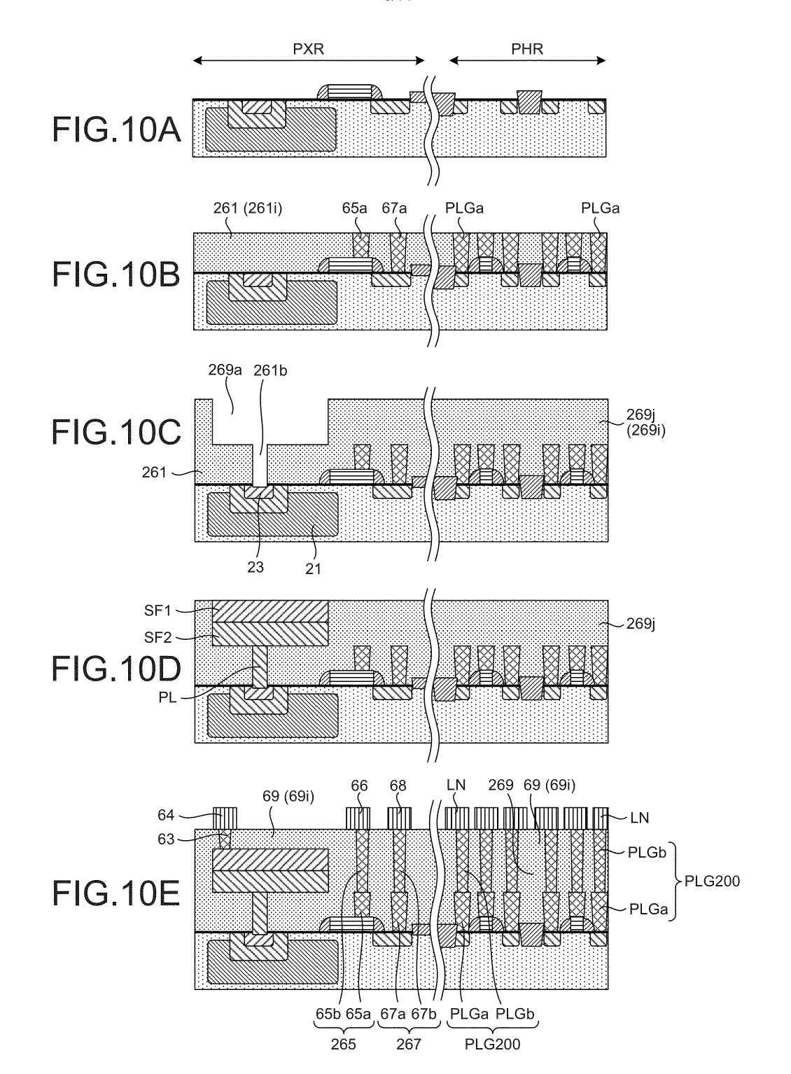

If, for performance required of the solid-state imaging device 105, the semiconductor films SF1, SF2 of the second semiconductor material having a narrower band gap are set thicker, the height difference between the semiconductor substrate SB and the top of the semiconductor film SF1 will be greater, and thus the formation of plugs 65, 67, PLG by a batch process may be difficult. In this case, the formation process for these plugs can be divided into two stages before and after the growth processes for the plugs PL and semiconductor films SF2, SF1 and performed. For example, the solid-state imaging device 105 can be manufactured as shown in FIGS. 10A to 10E. FIGS. 10A to 10E are process step cross-sectional views showing the manufacturing method of the solid-state imaging device 105 according to a modified example of the embodiment.

In the step shown in FIG. 10A, similar process to that in the step shown in FIG. 8A is performed.

In the step shown in FIG. 10B, an interlayer insulating film 261i is deposited by the CVD method or the like. Then holes are formed in the interlayer insulating film 261 using lithography and dry etching, and plugs 65a, 67a, PLGa are formed using sputtering and CMP.

In the step shown in FIG. 10C, an interlayer insulating film 269i is deposited by the CVD method so as to cover the interlayer insulating film 261 and plugs 65a, 67a, PLGa. Then recesses 269a are formed in areas directly above the first regions 21 where to grow the semiconductor films SF1, SF2, and holes 261b are formed in areas where to grow plugs PL. The holes 261b are formed extending from the bottoms of the recesses 269a through the interlayer insulating film 261j so as to expose the surfaces of the third regions 23.

In the step shown in FIG. 10D, the plugs PL, the semiconductor film SF2, and the semiconductor film SF1 are sequentially grown as in the step shown in FIG. 8C.

In the step shown in FIG. 10E, an interlayer insulating film 69i is deposited, and holes are formed in the interlayer insulating films 69, 269 using lithography and dry etching so as to expose the tops of the semiconductor film SF1 and the plugs 65a, 67a, PLGa. A conductive substance is filled in the holes using sputtering and CMP to form plugs 63, 65b, 67b, PLGb. Thus, a plug 265 including the plugs 65b and 65a is formed; a plug 267 including the plugs 67b and 67a is formed; and a plug PLG200 including the plugs PLGb and PLGa is formed. Then lines 64, 66, 68, LN are formed using sputtering, lithography, and dry etching.

As such, by dividing the formation process for the plugs 265, 267, PLG200 into two stages before and after the growth processes for the plugs PL and semiconductor films SF2, SF1 and performing the two-stage process, even where the height difference between the semiconductor substrate SB and the top of the semiconductor film SF1 is large, the structure of the present embodiment can be formed.

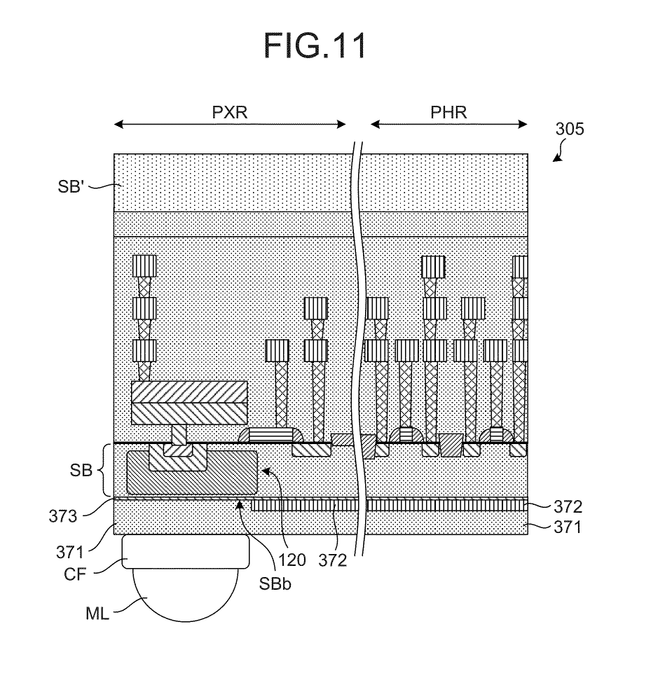

Alternatively, where the solid-state imaging device 305 is a back-side irradiation type of solid-state imaging device, the step shown in FIG. 11 may be performed after the step shown in FIG. 8D. FIG. 11 is a view showing the manufacturing method of the solid-state imaging device 305 according to another modified example of the embodiment.

In the step shown in FIG. 11, after the formation of a line layer, for the formation of the back-side irradiation type of solid-state imaging element, the semiconductor substrate SB is stuck to a support substrate SB′. For example, a silicon wafer or the like is used as the material for the support substrate SB′. For sticking them together, bonding using an adhesive may be performed, or direct bonding using intermolecular force control may be used. Then the semiconductor substrate SB is made thin to have a thickness of 3 μm or less by grinding using mechanical polishing or wet etching.

Then a protective layer 373 is formed on the light incidence surface side of the semiconductor substrate SB to protect the charge storage portion 120. The protective layer 373 is placed adjacent to the back side face SBb of the semiconductor substrate SB to protect the first region 21. The protective layer 373 is formed of the first semiconductor material (e.g., silicon) containing a second-conductivity-type impurity at a higher concentration than the first region 21. A method using ion implantation, laser annealing, and the like, a method of forming a fixed charge film, etc., is used in the formation of the protective layer 373. FIG. 11 illustrates the method of forming a fixed charge film.

Then a light shield film 372 is formed to shield the areas other than the photoelectric conversion portion 10 in the pixel region PXR and the peripheral circuit region PHR from light. The solid-state imaging device 305 can be prevented by the light shield film 372 from malfunctioning due to incident light. The light shield film 372 can be formed of a material composed mainly of metal such as aluminum or tungsten.

After the light shield film 372 is formed, a flattening film 371 is deposited by a CVD method or the like, and after flattening by CMP, color filters CF and micro-lenses ML in a desired pattern are formed using lithography and dry etching. The second semiconductor material having a narrower band gap such as germanium or silicon germanium has a large optical absorption constant, and light of short wavelengths is absorbed in the surface of the solid-state imaging device 305 and hardly taken into the charge storage portion 120. The back-side irradiation type of solid-state imaging device 305 of the present modified example can have a higher sensitivity to light of short wavelengths than the front-side irradiation type, in which light is incident directly on the second semiconductor material having a narrower band gap such as germanium or silicon germanium, because light of short wavelengths can be photoelectrically converted in the PN junction areas in the semiconductor substrate SB.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a charge storage portion formed of a first semiconductor material; and
a photoelectric conversion portion formed of a second semiconductor material having a narrower band gap than the first semiconductor material,
wherein the charge storage portion forms an overflow potential in a connection area with the photoelectric conversion portion so that charges generated in the photoelectric conversion portion in response to incident light can overflow the overflow potential into the charge storage portion.

2. The solid-state imaging device according to claim 1, wherein
the photoelectric conversion portion is placed above the charge storage portion.

3. The solid-state imaging device according to claim 2, wherein
the photoelectric conversion portion has:
a first portion of a first conductivity type; and
a second portion of a second conductivity type placed closer to the charge storage portion than the first portion, and
wherein the charge storage portion has:
a first region of the second conductivity type that stores charges having overflowed the overflow potential from the second portion; and
a second region placed between the second portion and the first region, the second region forming the overflow potential.

4. The solid-state imaging device according to claim 3, wherein
the second region contains an impurity of the first conductivity type.

5. The solid-state imaging device according to claim 3, wherein
the second region is an intrinsic semiconductor region.

6. The solid-state imaging device according to claim 3, wherein
the second region contains an impurity of the second conductivity type at a lower concentration than both the second portion and the first region.

7. The solid-state imaging device according to claim 3, wherein
the first region is provided in a semiconductor substrate, and the second region is provided in the semiconductor substrate and on the first region, and
wherein the first and second portions respectively include first and second semiconductor films placed above the second region.

8. The solid-state imaging device according to claim 7, wherein
the second portion further includes a plug electrically connecting the second semiconductor film to the second region.

9. The solid-state imaging device according to claim 8, wherein
the charge storage portion further has a third region of the second conductivity type placed adjacent to the surface of the semiconductor substrate so as to electrically connect the plug to the second region.

10. The solid-state imaging device according to claim 9, wherein
the charge storage portion further has a fourth region of the first conductivity type placed adjacent to the surface of the semiconductor substrate.

11. The solid-state imaging device according to claim 7, wherein
when seen through the imaging device in a direction perpendicular to the surface of the semiconductor substrate, each of the first semiconductor film and the second semiconductor film has a shape corresponding to the first region.

12. The solid-state imaging device according to claim 11, wherein
when seen through the imaging device in a direction perpendicular to the surface of the semiconductor substrate, each of the first semiconductor film and the second semiconductor film is included in the first region.

13. The solid-state imaging device according to claim 11, wherein
when seen through the imaging device in a direction perpendicular to the surface of the semiconductor substrate, each of the first semiconductor film and the second semiconductor film includes the first region.

14. The solid-state imaging device according to claim 7, wherein
a reference potential is supplied to the first semiconductor film, and the overflow potential is a potential between the reference potential and a power supply potential.

15. The solid-state imaging device according to claim 14, wherein
the overflow potential is a potential closer to the reference potential than an intermediate potential between the reference potential and power supply potential.

16. The solid-state imaging device according to claim 14, further comprising:
a charge-voltage conversion region of the second conductivity type placed in the semiconductor substrate; and
a transfer gate that transfers charges in the first region to the charge-voltage conversion region.

17. The solid-state imaging device according to claim 16, wherein
the potential of the charge-voltage conversion region is set at a potential corresponding to the power supply potential before charge storage operation by the charge storage portion is started.

18. A solid-state imaging device comprising:
a charge storage portion formed of a first semiconductor material; and
a photoelectric conversion portion formed of a second semiconductor material having a narrower band gap than the first semiconductor material, the photoelectric conversion portion having a first portion of a first conductivity type and a second portion of a second conductivity type placed closer to the charge storage portion than the first portion,
wherein the charge storage portion has a first region of the second conductivity type that stores charges generated in the photoelectric conversion portion in response to incident light and a second region of the first conductivity type placed between the second portion and the first region.

19. The solid-state imaging device according to claim 18, wherein
the first region is provided in a semiconductor substrate, and the second region is provided in the semiconductor substrate and on the first region, and
wherein the first and second portions respectively include first and second semiconductor films placed above the second region.

20. The solid-state imaging device according to claim 19, wherein
the second portion further includes a plug electrically connecting the second semiconductor film to the second region.
